(19) United States
(12) Patent Application Publication
(10) Pub. No.: US 2017/0211400 A1
(43) Pub. Date: Jul. 27, 2017

(54) STATOR VANE

(71) Applicant: SAFRAN AERO BOOSTERS S.A., Herstal (Milmort) (BE)

(72) Inventor: Frédéric Vallino, Seraing (BE)

(73) Assignee: SAFRAN AERO BOOSTERS S.A., Herstal (Milmort) (BE)

(21) Appl. No.: 15/410,540

(22) Filed: Jan. 19, 2017

(30) Foreign Application Priority Data
Jan. 21, 2016 (BE) 2016/5048

(51) Int. Cl. F01D 9/04

(52) U.S. Cl. CPC F01D 9/041; F05D 2220/323; F05D 2300/505; F05D 2240/124; F05D 2240/123; F05D 2240/121; F05D 2240/122

(57) ABSTRACT

Stator vane for a turbine engine and including at least one portion made from material suitable for superelasticity. The portion made from material suitable for superelasticity is arranged so as to start to resonate at a predetermined speed of the turbine engine, in particular during a speed of the turbine engine typical of the cruising phase of the aircraft.

### FIELD OF THE DISCLOSURE

According to a first aspect, embodiments of the present invention relate to a stator vane (or stator blade) of a low-pressure compressor of a turbine engine.

More precisely, embodiments of the present invention relate to a stator vane designed for a stator of a low-pressure compressor of an aircraft turbine engine. According to a second aspect, embodiments of the present invention relate to a method for detaching the ice from a stator vane of a stator of a low-pressure compressor of a turbine engine.

### BACKGROUND

The document U.S. 2011/0318181 A1 discloses the use of a viscoelastic material in a turbine-engine aerodynamic profile. When ice accumulates on the aerodynamic profile, the imbalance in stability that results therefrom causes a vibration in the profile. The viscoelastic material damps this vibration, and this damping causes heating that melts the ice.

However, the heating due to the damping is not capable of melting the ice if it is in the form of blocks.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect, one of the objects of embodiments of the present disclosure is to provide a stator vane capable of more effectively detaching ice present thereon, in particular when the ice is present in the form of blocks. To this end, embodiments herein propose a stator vane designed for a turbine-engine stator, the vane including at least one portion made from material suitable for superelasticity, wherein the at least one portion made from material suitable for superelasticity is arranged to start to resonate at a predetermined speed of the turbine engine.

By virtue of the resonance, the portion made from material suitable for superelasticity begins to vibrate, which means that the ice becomes detached therefrom, even if the ice is in the form of blocks. In some embodiments, the vane returns to a normal state (no resonance) when the ice detaches.

In addition, the vibrations minimize the formation of ice.

In some embodiments, the whole of the vane consists of a shape-memory material suitable for superelasticity and arranged to start to resonate at a predetermined speed of the turbine engine.

The physical effect used by the embodiments disclosed herein is different from the effect proposed by the document U.S. 2011/0318181 A1 since the latter uses a damping of the vibrations whereas the disclosed embodiments use the amplitude of the vibrations, which is particularly great in resonance. There is no resonance in the vane described in the document U.S. 2011/0318181 A1 since there appears therein a damping of the vibrations that is a physical effect opposed to the phenomenon of resonance. The arrangement of the vane of the disclosed subject matter, a portion of which is designed to resonate, is consequently different from that of the vane described in the document U.S. 2011/0318181 A1.

The resonance causes an increase in the vibrations in the vane portion made from material suitable for superelasticity. The vibrations thus amplified preferentially have a maximum amplitude of 10%, in some embodiments a maximum of 5%, and in some further embodiments a maximum of 2%, of the size of the vane portion made from material suitable for elasticity.

It is interesting to note that aspects of the disclosed subject matter run counter to the preconceived ideas of persons skilled in the art, according to which it is detrimental for a portion of a stator vane to start to resonate, since the vibrations due to the resonance risk damaging the portion in question. In the context of the disclosed subject matter, the superelasticity of the portion makes it possible to solve this problem since the characteristics of this type of material make it possible for the portion in question not to be damaged by the vibrations due to the resonance.

In the context of the present disclosure, “resonance” is an increase in the amplitude of a vibration under the influence of periodic pulses with a frequency close to the frequency of the vibration.

The arrangement of the portion made from material suitable for superelasticity means that one or more of the following characteristics are designed so that the portion made from material suitable for superelasticity starts to resonate at a predetermined speed of the turbine engine: the form of the portion, the form of the vane, the dimensions of the portion, the Young's modulus of the portion, the dimensions of the vane, the position of the portion in the vane, the mass of the portion and the mass of the vane, and the presence of ice on the vane or on the portion made from shape-memory material.

In the present disclosure, a “predetermined speed” of the turbine engine may correspond to a range of numbers of rotations made by the turbine engine per unit of time, to a range of proportions of full admission of the turbine engine, to a range of speeds of the aircraft propelled by the turbine engine, to a range of flight altitudes of an aircraft propelled by the turbine engine or to a flight phase (such as takeoff, cruising or landing) of an aircraft propelled by the turbine engine.

For example, a range of numbers of rotations corresponding to a determined speed may be between 5000 and 20,000 revolutions per minute, and in some embodiments between 7000 and 12,000 revolutions per minute.

For example, a range of proportions of full admission of the turbine engine may be between 65% and 90% of full admission, in some embodiments between 75% and 85%.

For example, a speed range of an aircraft propelled by the turbine engine may be between 300 and 1200 km/h, in some embodiments between 500 and 800 km/h.

For example, a range of flight altitudes of an aircraft propelled by the turbine engine may be between 6000 and 15,000 m, in some embodiments between 8000 and 12,000 m.

In one embodiment, the predetermined speed of the turbine engine corresponds to a cruising speed of an aircraft comprising the turbine engine.

In some embodiments, the at least one portion made from material suitable for superelasticity is arranged so as to be in a superelasticity state in a range of temperatures where the temperature is negative.

It is particularly advantageous that, during the flight phase, for example cruising flight, where the temperature of the air passing around the stator vane is negative, the turbine engine is operating at a speed causing resonance of the portion made from material suitable for superelasticity and the material suitable for superelasticity is in a superelastic state, since it is when the temperature is negative that there is a risk of formation of ice on the vane. In particular, in a cruising speed of an aircraft comprising the turbine engine, the air surrounding the aircraft may have a temperature of −60° C. to −20° C., in particular from −57° C. to −40° C., more particularly from −57° C. to −30° C.

The air entering the turbine engine can be heated therein as it passes through. It may therefore be advantageous, in particular for a portion made from material suitable for superelasticity in contact with the heated air, to have a superelasticity state in the range of typical temperatures of the air in contact with this portion at cruising speed, which may be a range of temperatures higher than the atmospheric temperatures typical of a cruising speed.

According to various embodiments, which can be taken together or separately:

at least one portion made from material suitable for superelasticity is arranged so as to be in a superelasticity state in a range of temperatures from −57° C. to −30° C.;

the material suitable for superelasticity is a shape-memory material;

the at least one portion made from material suitable for superelasticity is disposed on the suction face of the vane;

the at least one portion made from material suitable for superelasticity is disposed on the pressure face of the vane;

the at least one portion made from material suitable for superelasticity is disposed on the leading edge of the vane;

the at least one portion made from material suitable for superelasticity is disposed on the trailing edge of the vane; and

the at least one portion made from material suitable for superelasticity is situated at an intermediate height between an inner collar and an outer collar of the stator.

The embodiments of the present disclosure further relate to a turbine engine comprising a stator having a stator vane according to the disclosed subject matter and an aircraft comprising said turbine engine.

According to a second aspect, one of the objects of the disclosed subject matter is to provide a method for detaching ice from a stator vane of a turbine engine effectively. To this end a method is provided for detaching ice from a stator vane of a low-pressure compressor of a turbine engine and comprises the following:

providing a turbine engine comprising a low-pressure compressor having a stator with a stator vane including at least one portion made from material suitable for superelasticity arranged so as to be in a superelasticity state in a range of temperatures where the temperature is negative;

exposing the stator vane to a negative temperature so as to put at least one portion made from material suitable for superelasticity in a superelastic state and subjecting the at least one portion to moisture conditions such that ice can be deposited on at least one portion; and

setting the turbine engine to a speed such that at least one portion made from material suitable for superelasticity starts to resonate.

The advantages mentioned for the device apply mutatis mutandis to the method.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 illustrates a vane and sleeves forming part of a stator, in one embodiment of the present disclosure;

FIGS. 2a, 2b, 2c, 2d each illustrate a section of the vane with the portion made from material suitable for superelasticity positioned at various points on the vane; and

FIG. 3 illustrates an embodiment in which the portion made from material suitable for superelasticity is at an intermediate height between the inner collar and the outer collar.

### DETAILED DESCRIPTION

The present disclosure is described with particular embodiments and references to figures but the claimed subject matter is not limited to these. The drawings or figures described are merely schematic and are not limitative.

In the context of the present disclosure, the terms “first” and “second” serve only to differentiate the various elements and do not imply any order between these elements. In the figures, the identical or similar elements may bear the same references.

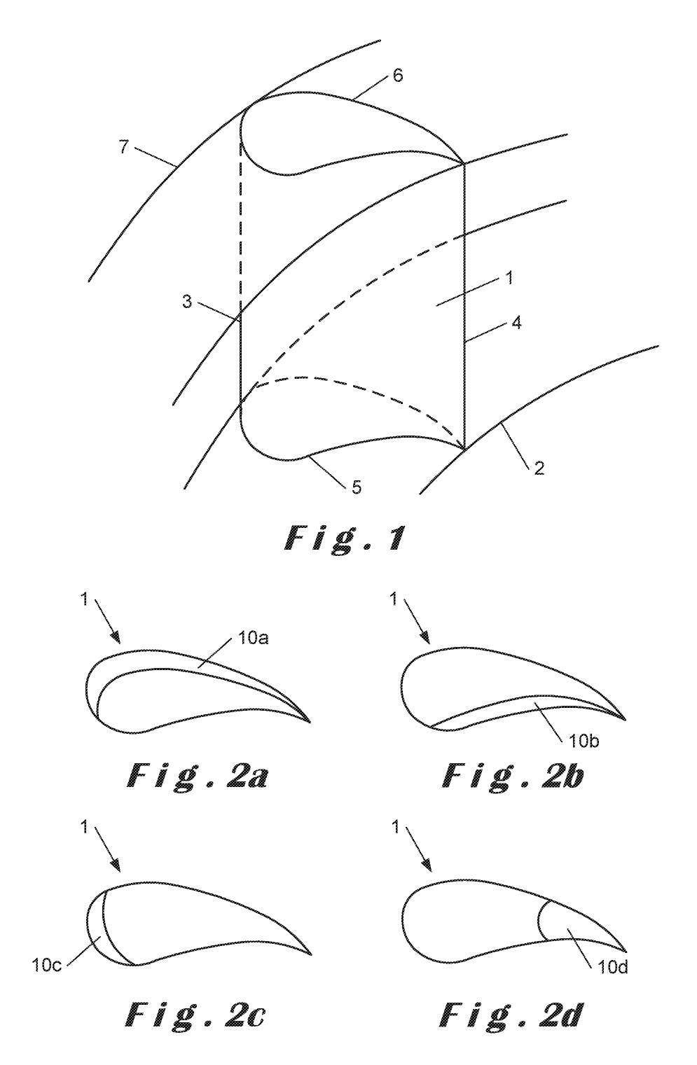

FIG. 1 illustrates a stator vane 1 and a piece of an inner collar 2, and a piece of an outer collar 7 forming part of a stator, in one embodiment of the invention, the stator vane 1 being in a first configuration. The vane 1 is fixed to the collars 2, 7 so that the vane 1 can deform with respect to the collars 2, 7. The vane 1 has a leading-edge line 3, a trailing-edge line 4, a pressure surface 5 and a suction surface 6. The pressure surface 5 is the concave surface of the vane 1 and the suction surface 6 is the convex surface of the vane 1.

In one embodiment, the stator vane 1 is fixed to a single collar. In one embodiment, at least one of the collars is made from platforms. The outer collar 7 is preferentially fixed to a casing.

The stator in some embodiments comprises an annular row of stator vanes 1. The stator vane 1 is used in some embodiments in a guide vane assembly for a compressor of an aircraft turbine engine.

The vane 1 comprises a portion made from a material able to take a superelastic state, that is to say a material suitable for superelasticity.

In some embodiments, the vane 1 comprises a means, methodologies or techniques for maintaining the amplitude of the vibrations in the vane portion made from material suitable for superelasticity in a range between −10% and 10% of the size of the vane portion made from material suitable for superelasticity. In some embodiments, the vane 1 comprises a means, methodologies or techniques for maintaining the amplitude of the vibrations in the vane portion made from material suitable for superelasticity in a range between −5% and 5% of the size of the vane portion made from material suitable for superelasticity. In some other embodiments, the vane 1 comprises a means, methodologies or techniques for maintaining the amplitude of the vibrations in the vane portion made from material suitable for superelasticity in a range between −2% and 2% of the size of the vane portion made from material suitable for superelasticity.

The stator vane 1 is particularly suitable for a turbine engine, in particular for an aircraft turbine engine, and in particular for a low-pressure compressor in a turbine engine.

The portion made from material suitable for superelasticity is arranged to vibrate with sufficient amplitude during resonance thereof to detach ice present thereon. In the context of the present document, the ice may be frost.

The portion made from material suitable for superelasticity is in some embodiments arranged so as to be in a superelasticity state in a temperature range where ice risks forming thereon, in particular in a temperature range where the temperature is negative.

The portion made from material suitable for superelasticity is arranged to start to resonate when the turbine engine comprising the stator vane 1 enters a predetermined speed. This speed may for example be a cruising speed of an aircraft comprising the turbine engine, since it is typically during the flight phase of the of the aircraft that corresponds to this speed that negative temperatures risking creating ice on the vane 1 are encountered by the vane 1.

In particular, the material suitable for superelasticity may be a shape-memory material. The shape-memory material is preferentially a shape-memory alloy, for example Ni—Ti, Cu—Al—Zn, Cu—Ni, Cu—Z—Ni or Cu—Ni—Al. The memory material may change from an austenite phase to a martensite phase according to its temperature and/or a mechanical stress to which it is subjected.

The portion of material suitable for superelasticity preferentially undergoes education before the vane 1 is installed in the turbine engine. The education comprises the repetition of a cycle between a first set of parameter values and a second set of parameter values, the parameters preferentially being the temperature and mechanical stress to which the material is subjected.

In one embodiment, the entire vane 1 is made from the material suitable for superelasticity. In other embodiments, a part of the vane 1, which is the portion made from material suitable for elasticity, is made from a material suitable for superelasticity. In other embodiments, a plurality of parts of the vane 1 are made from the shape-memory material, that is to say the vane 1 comprises a plurality of portions in a material suitable for superelasticity.

FIG. 2a illustrates a cross section of the vane 1 in an embodiment in which the portion 101a made from material suitable for superelasticity is disposed on the suction surface 6.

FIG. 2b illustrates a cross section of the vane 1 in an embodiment in which the portion 10b made from material suitable for superelasticity is disposed on the pressure surface 5.

FIG. 2c illustrates a cross section of the vane 1 in an embodiment in which the portion 10c made from material suitable for superelasticity is disposed on the leading edge 3.

FIG. 2d illustrates a cross section of the vane 1 in an embodiment in which the portion 10d made from material suitable for superelasticity is disposed on the trailing edge 4.

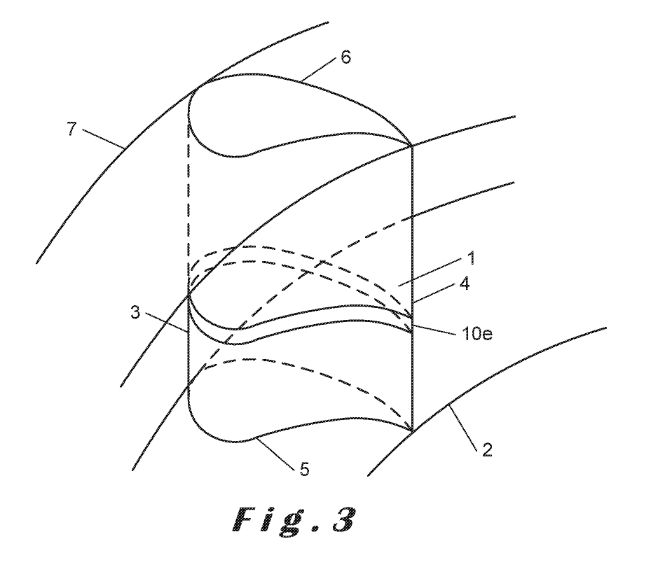

FIG. 3 illustrates an embodiment in which the portion 10e made from material suitable for superelasticity is at an intermediate height between the inner collar 2 and the outer collar 7.

The embodiments in FIGS. 2a, 2b, 2c, 2d, and 3 can be combined together, for example in an embodiment where the portion 10 made from material suitable for superelasticity is at an intermediate height between the inner collar 2 and the outer collar 7 and only close to the leading edge 3.

In other words, embodiments of the present disclosure relate to a stator vane 1 that includes a portion 10 made from material suitable for superelasticity. The portion 10 made from material suitable for superelasticity is arranged so as to resonate at a predetermined speed of the turbine engine, in particular during a speed of the turbine engine typical of the cruising phase of the aircraft. Furthermore, the material suitable for superelasticity is arranged so as to be in a superelastic state when ice risks forming thereon, in particular at temperatures typical of the aircraft cruising phase. Consequently, during the cruising phase, during which ice risks forming on the portion 10 made from material suitable for superelasticity, the vibrations due to the resonance prevent the formation of ice, and in particular blocks of ice, and the superelasticity of the portion 10 made from material for superelasticity means that it is not damaged by said vibrations.

One could have used stator blade instead stator vane for describing suitable uses for aspects of the present disclosure.

The disclosed subject matter has been described in relation to specific embodiments, which have a purely illustrative value and must not be considered to be limitative. In general terms, embodiments of the present disclosure are not limited to the examples illustrated and/or described above. The use of the verbs “comprise”, “include”, “have” or any other variant, as well as conjugations thereof, can in no way exclude the presence of elements other than those mentioned. The use of the indefinite article “a” or “an” or of the definite article “the” to introduce an element does not exclude the presence of a plurality of these elements. The reference numbers in the claims do not limit their scope.

While illustrative embodiments have been illustrated and described, it will be appreciated that various changes can be made therein without departing from the spirit and scope of the claimed subject matter.

1. Stator vane for a stator of a low-pressure compressor of a turbine engine, the vane comprising at least one portion made from shape-memory material suitable for superelasticity, wherein the at least one portion made from shape memory material suitable for superelasticity is arranged to start to resonate at a predetermined speed of the turbine engine.

2. The stator vane of claim 1, in which the predetermined speed of the turbine engine corresponds to a cruising speed of an aircraft comprising the turbine engine.

3. The stator vane of claim 2, in which the at least one portion made from shape-memory material suitable for superelasticity is arranged so as to start to resonate when it is covered with ice.

4. The stator vane of claim 1, in which the portion made from shape-memory material suitable for superelasticity is arranged so as to be in a superelasticity state in a temperature range from −57° C. to −30° C.

5. The stator vane of claim 1, wherein it consists entirely of a shape-memory material suitable for superelasticity and arranged to start to resonate at a predetermined speed of the turbine engine.

6. The stator vane of claim 1, in which the at least one portion made from shape-memory material suitable for superelasticity is disposed on a suction surface of the vane.

7. The stator vane of claim 1, in which the at least one portion made from shape-memory material suitable for superelasticity is disposed on a pressure surface of the vane.

8. The stator vane of claim 1, in which the at least one portion made from shape-memory material suitable for superelasticity is disposed on a leading edge of the vane.

9. The stator vane of claim 1, in which the at least one portion made from shape-memory material suitable for superelasticity is disposed on a trailing edge of the vane.

10. The stator vane of claim 1, in which the at least one portion made from shape-memory material suitable for superelasticity is situated at an intermediate height between an inner collar and an outer collar of the stator.

11. Turbine engine comprising a low-pressure compressor comprising a stator having a stator vane of claim 1.

12. Aircraft comprising the turbine engine of claim 11.

13. Method for detaching ice from a stator vane of a stator of a low-pressure compressor of an aircraft turbine engine, comprising:
providing a turbine engine comprising a low-pressure compressor having a stator comprising a stator vane including at least one portion made from shape-memory material suitable for superelasticity arranged so as to be in a superelasticity state in a range of negative temperatures;
exposing the stator vane to a temperature in said range of the previous step so as to put at least one portion made from shape-memory material suitable for superelasticity in a superelastic state and subjecting the at least one portion to moisture conditions such that ice can be deposited on at least one portion; and
setting the turbine engine to a speed such that at least one portion made from material suitable for superelasticity starts to resonate.

14. The method of claim 13, wherein said range of negative temperatures is between −57° C. and −30° C.
